(19) United States
(12) Patent Application Publication
(10) Pub. No.: US 2013/0318335 A1
(43) Pub. Date: Nov. 28, 2013

(54) COMPUTING DEVICE AND METHOD OF CAPTURING SHUTDOWN CAUSE IN SAME

(71) Applicant: HON HAI PRECISION INDUSTRY CO., LTD., New Taipei (TW)

(72) Inventors: CHEN-YANG WU, New Taipei (TW); CHIH-HSIUNG HSIEH, New Taipei (TW)

(73) Assignee: HON HAI PRECISION INDUSTRY CO., LTD., New Taipei (TW)

(21) Appl. No.: 13/851,262

(22) Filed: Mar. 27, 2013

(30) Foreign Application Priority Data
May 22, 2012 (TW) 101118152

(51) Int. Cl. G06F 9/44

(52) U.S. Cl. CPC G06F 9/442
USPC 713/2

(57) ABSTRACT

A computing device includes an embedded controller. The embedded controller suspends a shutdown process in response to detection of a shutdown command, and obtains a shutdown cause according to the shutdown command. The embedded controller includes a memory. The embedded controller stores the shutdown cause in the memory, and resumes the shutdown process after the shutdown cause has been stored in the memory. A method of capturing shutdown cause in a computing device is also provided.

### REFERENCE TO RELATED APPLICATIONS

This application claims all benefits accruing under 35 U.S.C. §119 from Taiwan Patent Application No. 101118152, filed on May 22, 2012 in the Taiwan

Intellectual Property Office. The contents of the Taiwan Application are hereby incorporated by reference.

### BACKGROUND

1. Technical Field

The disclosure generally relates to a computing device and a method of capturing shutdown cause in the computing device.

2. Description of Related Art

As known in the art, computers may be shut down for a variety of causes including expected causes such as a power button being pressed, and unexpected causes such as a temperature of a hardware component exceeding a threshold value. The shutdown causes are valuable information for users or engineers to debug and maintain the computers. However, it is difficult to identify the shutdown causes, especially the unexpected shutdown causes, as a shutdown process is fast and short-lived.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a block diagram of one embodiment of a computing device equipped with an embedded controller.

FIG. 2 is a block diagram of one embodiment of the embedded controller of FIG. 1.

FIG. 3 is a table showing correspondence between shutdown commands and shutdown causes, according to one embodiment.

FIG. 4 is a flowchart showing one embodiment of a method for managing embedded controller firmware.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

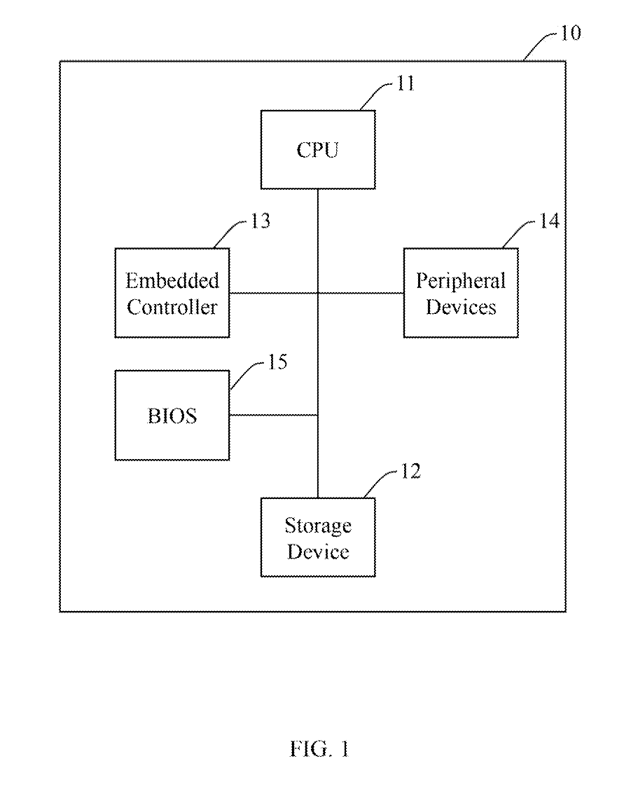

FIG. 1 shows one embodiment of a computing device 10. The computing device 10 includes a central processing unit (CPU) 11, a storage device 12, an embedded controller 13, a plurality of peripheral devices 14, and a basic input output system (BIOS) 15. The computing device 10 may be a personal computer, a workstation computer, a server computer, a tablet computer, or the like.

The CPU 11 is operably coupled to the storage device 12, the embedded controller 13, the peripheral devices 14, and the BIOS 15. The CPU 11 may include one or more processors that provide the processing capability to execute the operating system, programs, user and application interfaces, and any other functions of the computing device 10. The CPU 11 may include one or more microprocessors and/or related chip sets. For example, the CPU 11 may include “general purpose” microprocessors, a combination of general and special purpose microprocessors, instruction set processors, graphics processors, video processors, related chips sets, and/or special purpose microprocessors. The CPU 11 also may include onboard memory for caching purposes.

Information, such as programs and/or instructions, used by the CPU 11 may be located within the storage device 12. The storage device 12 may store a variety of information and may be used for various purposes. For example, the storage device 12 may store firmware for the computing device 10 (such as a basic input/output instruction or operating system instructions), various programs, applications, or routines executed on the computing device 10, user interface functions, processor functions, and so forth. In addition, the storage device 12 may be used for buffering or caching during operation of the computing device 10.

The storage device 12 may include any suitable manufacture that includes one or more tangible, computer-readable media. For example, the storage device 12 may include a volatile memory, such as random access memory (RAM), and/or as a non-volatile memory, such as read-only memory (ROM). The components may further include other forms of computer-readable media, such as non-volatile storage, for persistent storage of data and/or instructions. The non-volatile storage may include flash memory, a hard drive, or any other optical, magnetic, and/or solid-state storage media. The non-volatile storage may be used to store firmware, data files, software, wireless connection information, and any other suitable data.

The embedded controller 13 handles the peripheral devices 14 such as a keyboard, a mouse, a touchpad, a battery, a set of end-user controlled buttons (such as power button and sleep button), or any other relatively slow input/output (I/O) device that should be isolated from the CPU 11 in order to prevent degradation of the overall system performance. The embedded controller 13 also manages the Advanced Configuration and Power Interface (ACPI) of the computing device.

The BIOS 15 provides a consistent way for operating systems and application programs to interact with underlying hardware, such as a keyboard, a display, and other input/output devices. The BIOS 15 refers both a BIOS chip and BIOS software/firmware thereof. The BIOS 15 also provides a Real-time Clock (RTC) of operating systems and application programs.

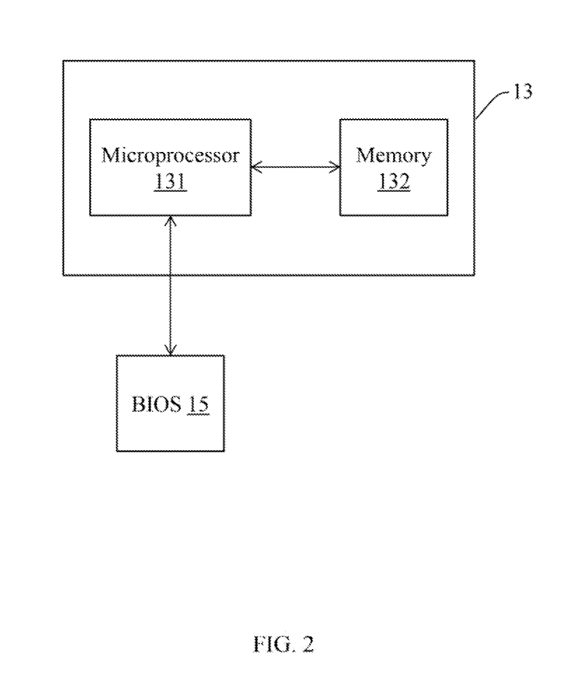

FIG. 2 shows a block diagram of one embodiment of the embedded controller 13. The embedded controller 13 includes a microprocessor 131, and a memory 132. The memory 132 is an electronic non-volatile computer storage device that can be electrically erased and programmed. In some embodiments, the memory 132 is a flash ROM.

The memory 132 stores embedded controller operating codes, also known as embedded controller firmware. The microprocessor 131 may read and execute the embedded controller firmware from the memory 132 to implement functionalities of embedded control of the peripheral devices 14 and the ACPI of the computing device 10.

The microprocessor 131 runs a resident routine to monitor whether a shutdown command is initiated. When a shutdown process is launched, the BIOS 15 sends a shutdown command to the microprocessor 131. When the resident routine detects the shutdown command, the microprocessor 131 suspends the shutdown process.

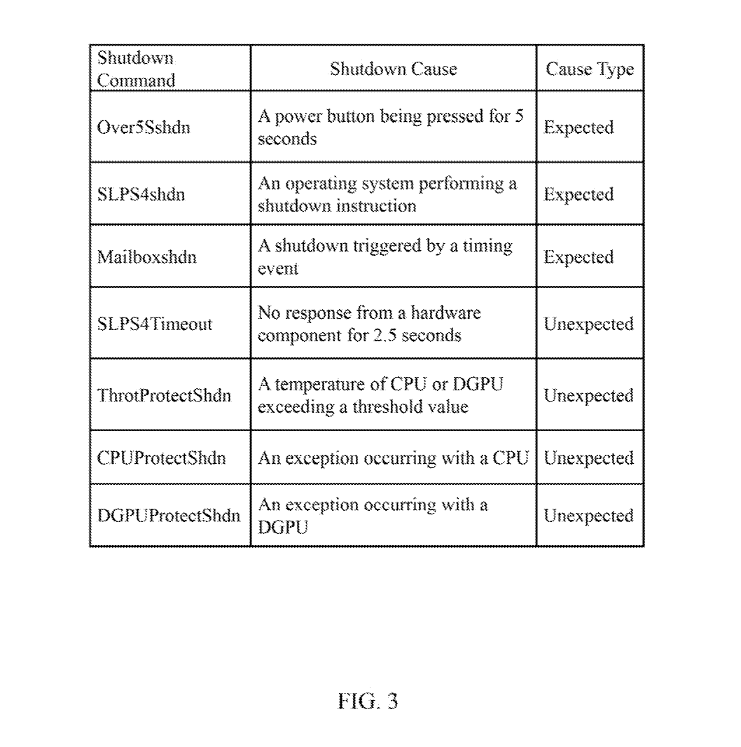

During the suspension of the shutdown process, the microprocessor 131 obtains a shutdown cause according to the shutdown command. As shown in FIG. 3, a table shows correspondence between some shutdown commands and shutdown causes. For example, a shutdown command “Over5Sshdn” corresponds to a shutdown cause “a power button being pressed for 5 seconds”. The microprocessor 131 may further send a RTC request to the BIOS 15 and receive a RTC time from the BIOS 15.

The microprocessor 131 may store the shutdown cause and the RTC time to the memory 132. In some embodiments, the microprocessor 131 defines filtering criteria. The microprocessor 131 determines whether the shutdown is an expected shutdown cause or an unexpected shutdown cause before storing the shutdown cause and the RTC time the memory 132. If the shutdown cause is an unexpected shutdown cause such as “a temperature of CPU or DGPU exceeding a threshold value”, the microprocessor 131 stores the shutdown cause and the RTC time to the memory 132. If the shutdown cause is an expected shutdown cause such as “a power button being pressed for 5 seconds”, the microprocessor 131 ignores the shutdown cause and does not store the shutdown cause or the RTC time to the memory 132.

After the shutdown cause has been treated as either recorded or ignored, the embedded controller 13 resumes the shutdown process and finally shuts down the computing device 10.

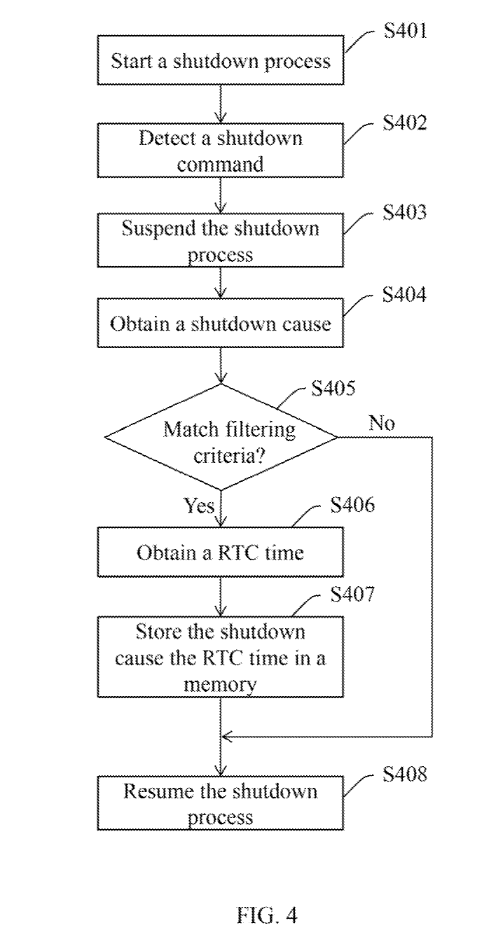

FIG. 4 is a flowchart showing one embodiment of a shutdown management method. The method comprises the following steps.

In step S401, a shutdown process is started. The BIOS 15 sends a shutdown command to the microprocessor 131.

In step S402, the resident routine run by the microprocessor 131 detects the shutdown command.

In step S403, the microprocessor 131 suspends the shutdown process.

In step S404, the microprocessor 131 obtains a shutdown cause according to the shutdown command

In step S405, the microprocessor 131 determines whether the shutdown cause matches filtering criteria. If the shutdown cause is an unexpected shutdown cause, the flow goes to step S405. If the shutdown cause is not an unexpected shutdown cause, the flow goes to step S407.

In step S406, the microprocessor 131 sends a RTC request to the BIOS 15 and obtains a RTC time from the BIOS 15.

In step S407, the microprocessor 131 stores the shutdown cause and the RTC time in the memory 132.

In step S408, the microprocessor 131 resumes the shutdown process and finally shuts down the computing device 10.

Although numerous characteristics and advantages have been set forth in the foregoing description of embodiments, together with details of the structures and functions of the embodiments, the disclosure is illustrative only, and changes may be made in detail, especially in the matters of arrangement of parts within the principles of the disclosure to the full extent indicated by the broad general meaning of the terms in which the appended claims are expressed.

In particular, depending on the embodiment, certain steps or methods described may be removed, others may be added, and the sequence of steps may be altered. The description and the claims drawn for or in relation to a method may give some indication in reference to certain steps. However, any indication given is only to be viewed for identification purposes, and is not necessarily a suggestion as to an order for the steps.

What is claimed is:

1. An embedded controller, comprising:
a memory; and
a microprocessor coupled to the memory, wherein the microprocessor is configured to suspend a shutdown process in response to detection of a shutdown command, to obtain a shutdown cause according to the shutdown command, to store the shutdown cause in the memory, and to resume the shutdown process after the shutdown cause has been stored in the memory.

2. The embedded controller of claim 1, wherein the microprocessor is further configured to obtain a Real-time Clock (RTC) time from a basic input output system (BIOS) in communication with the embedded controller.

3. The embedded controller of claim 2, wherein the microprocessor is further configured to store the RTC time together with the shutdown cause in the memory.

4. The embedded controller of claim 1, wherein the microprocessor is further configured to determine whether the shutdown cause is an unexpected shutdown cause or an excepted shutdown cause.

5. The embedded controller of claim 4, wherein the microprocessor is further configured, if the shutdown cause is an unexpected shutdown cause, to store the shutdown cause in the memory.

6. The embedded controller of claim 4, wherein the microprocessor is further configured, if the shutdown cause is an expected shutdown cause, to ignore the shutdown cause and not to store the shutdown cause in the memory.

7. The embedded controller of claim 4, wherein the microprocessor is further configured, if the shutdown cause is an unexpected shutdown cause, to obtain RTC time from the BIOS.

8. The embedded controller of claim 4, wherein the microprocessor is further configured, if the shutdown cause is an expected shutdown cause, not to obtain RTC time from the BIOS.

9. The embedded controller of claim 1, wherein the microprocessor is configured to run a resident routine to detect the shutdown command.

10. The embedded controller of claim 1, wherein the memory is an electronic non-volatile computer storage device that can be electrically erased and programmed.

11. A method of capturing shutdown cause of a computing device, the method comprising:
suspending a shutdown process in response to detection of a shutdown command by an embedded controller embedded in the computing device;
obtaining a shutdown cause according to the shutdown command by the embedded controller;
storing the shutdown cause in a memory of the embedded controller; and
resuming the shutdown process by the embedded controller.

12. The method of claim 11, further comprising obtaining a Real-time Clock (RTC) time from a basic input output system (BIOS) in communication with the embedded controller.

13. The method of claim 12, further comprising storing the RTC time together with the shutdown cause in the memory.

14. The method of claim 11, further comprising determining whether the shutdown cause is an unexpected shutdown cause or an excepted shutdown cause.

15. The method of claim 14, further comprising, if the shutdown cause is an unexpected shutdown cause, storing the shutdown cause in the memory.

16. The method of claim 14, further comprising, if the shutdown cause is an expected shutdown cause, ignoring the shutdown cause and not storing the shutdown cause in the memory.

17. The method of claim 14, further comprising, if the shutdown cause is an unexpected shutdown cause, obtaining RTC time from the BIOS.

18. The method of claim 14, further comprising, if the shutdown cause is an expected shutdown cause, not obtaining RTC time from the BIOS.

19. The method of claim 11, further comprising running a resident routine to detect the shutdown command by the embedded controller.

20. The method of claim 11, wherein the memory is an electronic non-volatile computer storage device that can be electrically erased and programmed
